(19) United States
(12) Patent Application Publication
(10) Pub. No.: US 2020/0117797 A1
(43) Pub. Date: Apr. 16, 2020

(54) AGENT INJECTION VIA COMMAND HIJACKING

(71) Applicant: CA, Inc., New York, NY (US)

(72) Inventor: DEVASIA ANTONY MUTHALAKUHY THOMAS, MILPITAS, CA (US)

(21) Appl. No.: 16/157,651

(22) Filed: Oct. 11, 2018

(51) Int. Cl. G06F 21/54; G06F 21/57; G06F 9/54

(52) U.S. Cl. CPC G06F 21/54; G06F 9/545; G06F 21/577

(57) ABSTRACT

Embodiments of the present disclosure relate to command modification. Initially, a first command is received from a user. The first command may include a target process that is issued to an operating system via a shell. Utilizing a pre-execution hook of the shell, the first command is hijacked before the first command is executed by the operating system. The first command may be passed to an agent injection engine that parses the first command and identifies at least a portion of the first command to be modified. A handler may be identified that is utilized by the agent injection engine to modify the first command to create a second command. The second command injects an agent that is not preloaded into memory into the target process and is executed by the operating system. The first command is prevented from being executed by the operating system.

### BACKGROUND

Commands are typically issued to an operating system via a shell that enables access to the services of the operating system. The shell provides a user interface (e.g., a command-line interface or a graphical user interface) that receives the command, verifies the command is valid, and communicates the command to a command processor to be executed. Some shells provide pre-execution and post-execution hooks that enable a user to run additional code or functions before or after the issued command is executed, respectively. Other shells require the user to perform additional actions for hooks that are not natively supported. Currently, pre-execution hooks are limited to preparing an environment for a command that is to run.

Agents are often paired with a process (i.e., injected into the process) to perform actions on behalf of the process (i.e., an instance of a program) or along with it. For example, an agent may collect data on behalf of the process for data-mining purposes that can be utilized to troubleshoot, monitor, or provide analytics for the process that is paired with the agent. Currently, agents can be injected into a process in two distinct ways. First, a user can manually modify the command. To do so is tedious, subject to errors, and requires immense effort in production environments. Moreover, this method may not be possible on remote deployments or when the user and the maintainer or developer of the deployment are not the same. Secondly, a user can take advantage of shared library preloading (e.g., LD_PRELOAD). Unfortunately, this method is highly intrusive, passes responsibility for any security flaws to the owner of the deployment (if a library is compromised, the entire system can be comprised), and results in a memory bloat for every process on the system.

### SUMMARY

This summary is provided to introduce a selection of concepts in a simplified form that are further described below in the detailed description. This summary is not intended to identify key features or essential features of the claimed subject matter, nor should it be used as an aid in determining the scope of the claimed subject matter.

Embodiments of the present disclosure relate to command modification. More particularly, embodiments of the present disclosure relate to injecting an agent into a process via command hijacking. Initially, a first command is received from a user. The first command may include a target process that is issued to an operating system via a shell. Utilizing a pre-execution hook of the shell, the first command is hijacked before the first command is executed by the operating system. The first command may be passed to an agent injection engine that parses the first command and identifies at least a portion of the first command to be modified. A handler may be identified that is utilized by the agent injection engine to modify the first command to create a second command. The second command injects an agent that is not preloaded into memory into the target process and is executed by the operating system. The first command is prevented from being executed by the operating system.

### BRIEF DESCRIPTION OF THE DRAWINGS

The present invention is described in detail below with reference to the attached drawing figures, wherein:

FIG. 1 is a block diagram showing a system that provides agent injection via command hijacking, in accordance with an embodiment of the present disclosure;

FIG. 2 is block diagram showing an agent injection engine that is utilized to perform agent injection via command hijacking, in accordance with embodiments of the present disclosure;

FIG. 3 is a flow diagram showing a method of providing agent injection via command hijacking, in accordance with embodiments of the present disclosure;

FIG. 4 is a flow diagram showing a method of injecting an agent into a process via command hijacking, in accordance with embodiments of the present disclosure;

FIG. 5 is a flow diagram showing a method of modifying a command, in accordance with embodiments of the present disclosure; and

FIG. 6 is a block diagram of an exemplary computing environment suitable for use in implementing embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

As noted in the background, commands are typically issued to an operating system via a shell that enables access to the services of the operating system. The shell provides a user interface (e.g., a command-line interface or a graphical user interface) that receives the command, verifies the command is valid, and communicates the command to a command processor to be executed. Some shells provide pre-execution and post-execution hooks that enable a user to run additional code or functions before or after the issued command is executed, respectively. Other shells require the user to perform additional actions for hooks that are not natively supported. Currently, pre-execution hooks are limited to preparing an environment for a command that is to run.

Agents are often paired with a process (i.e., injected into the process) to perform actions on behalf of the process (i.e., an instance of a program). For example, an agent may collect data on behalf of the process for data-mining purposes that can be utilized to troubleshoot, monitor, or provide analytics for the process that is paired with the agent. Currently, agents can be injected into a process in two distinct ways. First, a user can manually modify the command. To do so is tedious, subject to errors, and requires immense effort in production environments. Moreover, this method may not be possible on remote deployments or when the user and the maintainer or developer of the deployment are not the same. Secondly, a user can take advantage of shared library preloading (e.g., LD_PRELOAD). Unfortunately, this method is highly intrusive, passes responsibility for any security flaws to the owner of the deployment (if a library is compromised, the entire system can be comprised), and results in a memory bloat for every process on the system.

Embodiments of the present disclosure relate to command modification. More particularly, embodiments of the present disclosure relate to injecting an agent into a process via command hijacking. Initially, a first command is received from a user. The first command may include a target process that is issued to an operating system via a shell. Utilizing a pre-execution hook of the shell, the first command is hijacked before the first command is executed by the operating system. The first command may be passed to an agent injection engine that parses the first command and identifies at least a portion of the first command to be modified. A handler may be identified that is utilized by the agent injection engine to modify the first command to create a second command. The second command injects an agent (that is not preloaded into memory) into the target process and is executed by the operating system. The first command is prevented from being executed by the operating system.

Accordingly, one embodiment of the present disclosure is directed to a method. The method comprises receiving a first command from a user. The first command includes a target process that is issued to an operating system via a shell. The method also comprises hijacking the first command, utilizing a pre-execution hook of the shell, before the first command is executed by the operating system. The method further comprises modifying the first command to create a second command. The second command injects an agent into the target process. The method also comprises preventing the first command from being executed by the operating system.

In another embodiment, the present disclosure is directed to a computer storage medium storing computer-useable instructions that, when used by at least one computing device, cause the at least one computing device to perform operations. The operations comprise parsing, by an agent injection engine, a first command issued to an operating system via a shell. The first command includes a target process hijacked by the agent injection engine. The operations also comprise identifying at least a portion of the first command to be modified in accordance with the agent injection engine. The operations further comprise identifying, by the agent injection engine, a handler that is utilized by the agent injection engine to modify the first command into a second command. The second command injects an agent (that is not preloaded into memory) into the target process in accordance with the handler and is executed by the operating system instead of the first command.

In yet another embodiment, the present disclosure is directed to a computerized system. The system includes a processor and a computer storage medium storing computer-useable instructions that, when used by the processor, cause the processor receive a first command from a user. The first command includes a target process that is issued to an operating system via a shell. Utilizing a pre-execution hook of the shell, the first command is hijacked before it is executed by the operating system. It can then be determined whether to modify the first command to create a second command that injects an agent into the target process and prevents the first command from being executed by the operating system.

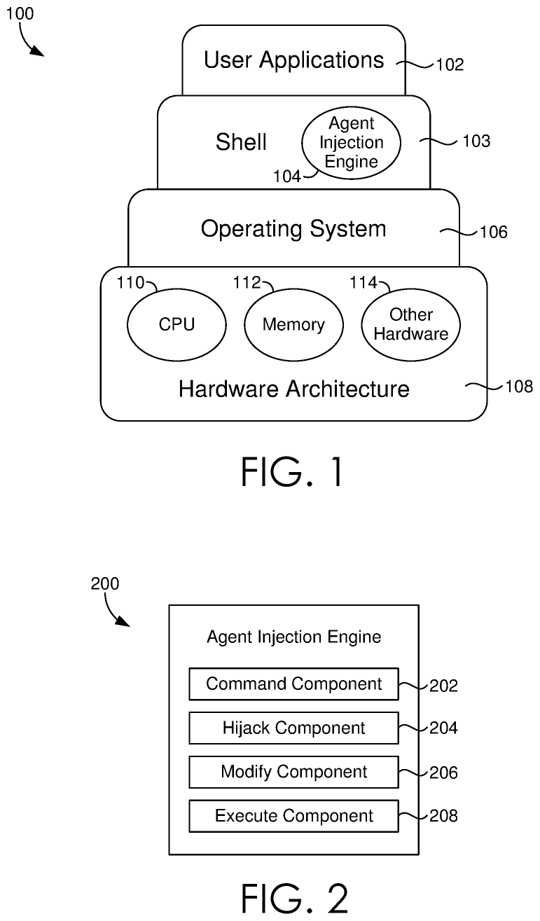

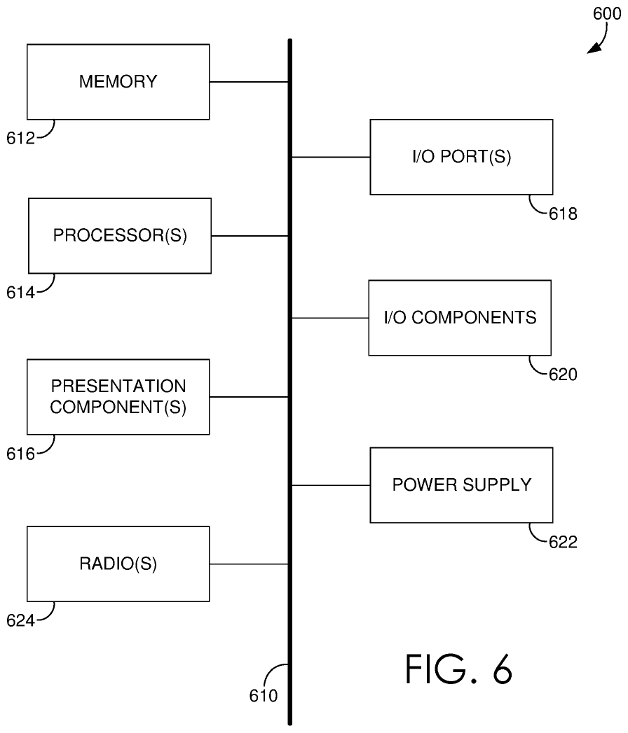

Referring now to FIG. 1, a block diagram is provided that illustrates a hijack system 100 that injects an agent into a process via command hijacking, in accordance with an embodiment of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. The hijack system 100 may be implemented via any type of computing device, such as computing device 600 described below with reference to FIG. 6, for example. In various embodiments, the hijack system 100 may be implemented via a single device or multiple devices cooperating in a distributed environment.

It should be understood that any number of agent injection engines may be employed within the hijack system 100 within the scope of the present disclosure. Each may comprise a single device or multiple devices cooperating in a distributed environment. For instance, the agent injection engine 104 (or any of its components: command component, hijack component, modify component, and execute component) may be provided via multiple devices arranged in a distributed environment that collectively provide the functionality described herein. In other embodiments, a single device may provide the functionality of multiple components of the hijack system 100. For example, a single device may provide the agent injection engine 104 and/or the user applications 102. In some embodiments, some or all functionality provided by the agent injection engine 104 (or any of its components) and/or the user applications 102 may be provided by a user device. Additionally, other components not shown may also be included within the hijack system 100.

As noted, the hijack system 100 generally operates to inject an agent into a process via command hijacking. As shown in FIG. 1, the hijack system 100 may include user applications 102, a shell of an operating system 103, an agent injection engine 104, operating system 106, and hardware architecture 108. The hardware architecture may include CPU 110, memory 112, and/or other hardware 114. It should be understood that the hijack system 100 shown in FIG. 1 is an example of one suitable computing system architecture. Each of the components shown in FIG. 1 may be implemented via any type of computing device, such as computing device 600 described with reference to FIG. 6, for example. Additionally, other components not shown may also be included within the environment.

The shell 103 enables a user or user applications 102 to interact with services of the operating system 106 with commands. The shell 103 may be a command-line interface or graphical user interface. Typically, the shell 103 requires a user to be familiar with the various commands, nuances corresponding to the shell scripting language, and resources available to the user. Examples of shells include, but are not limited to, Amiga shell, Bourne Again SHell (BASH), tcsh, Cshell, KornShell, Z shell, Fish, Emacs shell, CMD.EXE, iSeries QSHELL, DROS, Junos, and the like.

User applications 102 may further include programs or processes. For clarity, a process is an instance of a program that is being executed. The process may be allocated access to portions of the hardware architecture 108 by the operating system 106. For example, the operating system 106 may allocate CPU 110, memory 112, or other hardware 114 to the process.

User applications 102 may also include libraries. Libraries comprise non-volatile resources that can be utilized by computer programs and may include configuration data, documentation, help data, message templates, pre-written code and subroutines, classes, values, or type specifications. Libraries may also be utilized by a program to make system calls rather than implementing system calls over and over again. A library may be pre-loaded by the operating system 106 into memory 112 of each process. However, as described above, potential security issues may be introduced and the system can be compromised. Additionally, such pre-loading also results in memory bloat since the libraries are loaded for every process. Libraries, or components of a library (i.e., an agent) may also be loaded manually by a user via a shell 103. However, as described above, this manual process is tedious and prone to user error and may not even be possible (e.g., remote deployments, when the user and maintainer or developer of the deployment are not the same).

The libraries may include agents. Agents paired with a process (i.e., injected into the process) may perform actions on behalf of the process. For example, an agent may collect data on behalf of the agent for data-mining purposes that can be utilized to troubleshoot, monitor, or provide analytics for the process that is paired with the agent.

Generally, the agent injection engine 104 hijacks a command when it is issued via the shell 103 to the operating system 106 and, instead, executes a different command in lieu of the original command. In doing so, the problems associated with pre-loading libraries or manually loading an agent with a target process are alleviated (i.e., tediousness and errors reduced, security issues and memory bloat prevented).

As shown in FIG. 2, the agent injection engine 200 includes several components including a command component 202, a hijack component 204, a modify component 206, and an execute component 208. In practice, and referring to FIGS. 1 and 2, a first command is received from a user at the command component 202 of the agent injection engine 104 via the shell 103. The first command includes a target process (e.g., gunicorn) that is issued to the operating system via the shell (such as the operating system 106 and the shell 103 of FIG. 1).

Instead of issuing the first command to the operating system, the first command is hijacked by the hijack component 204 of the agent injection engine 200. To do so, a pre-execution hook of the shell is utilized before the first command is executed by the operating system. For example, the hijack component 204 may utilize pre-execution code that is sourced in a global location so it can be utilized for every command that is issued on the system. Alternatively, a location of the hijack component 204 may be identified by an environment variable.

In embodiments, the pre-execution code may initially set a debug trap and record the first command that is currently being processed. In some cases, the pre-execution code may include exceptions for cases where the first command should not be prevented from executing. These exceptions may exit the pre-execution code and enable the first command to be issued to the operating system and executed as is.

In cases where the first command should be prevented from executing, the recorded command may be passed to the modify component 206 of the agent injection engine 200. The modify component 206 modifies the first command as it would have been done manually by a user so an agent can be injected into the process. As can be appreciated, since the command modification is done automatically by the modify component 206, the tediousness and errors that are the product of manual command modification are eliminated. Moreover, security issues and memory bloat that are the product of shared library preloading are avoided. An exemplary pre-execution pseudo code is shown in Table 1.

TABLE 1

Set debug flag
Do nothing if particular commands are issued as the first command
Record the first command
Pass the first command to the modify component
If nothing is returned by the modify component,

Do nothing

If a second command is returned, execute the second command

Force the first command to not execute

To perform the command modification, the modify component 206 initially determines whether to modify the first command to create a second command that injects an agent into the target process. Upon determining that the first command should be modified to create a second command, the modify component 206 parses the first command to identify at least a portion of the first command that is to be modified. Once the portion of the first command is identified, the modify component 206 identifies a handler that is utilized to modify the first command. The handler corresponds to a category of the first command (e.g., Java handler, Python handler, etc.). In other words, the modify component 206 selects the handler based on the technology utilized corresponding to the first command. Exemplary pseudo handlers for Java and Python are shown in Tables 2 and 3, respectively.

TABLE 2
package handlers
import (

“strings”

)
func JModify(argList [ ]string, pos int) string {

for _, word := range argList {

if strings.HasPrefix(word, “-

Dcom.wily.introscope.agentProfile=”) {

// do nothing
return “ ”

}

}
if argList[pos] == “org.apache.catalina.startup.Bootstrap” &&

pos+1 < len(argList) && argList[pos+1] == “start” {

argList = append(argList, “ ”)
copy(argList[pos+1:], argList[pos:])
argList[pos] = “-javaagent:/opt/wily/Agent.jar -

Dcom.wily.introscope.agentProfile=/opt/wily/core/config/IntroscopeAgent.p
rofile”

return strings.Join(argList, “ ”)

} else {

return “ ”

}

}

TABLE 3

package handlers
import (

“strings”

)
func PyModify(argList [ ]string, pos int) string {

for _. word := range argList {

if word == “ca-apm-runpy” {

//do nothing
return “”

}

}
return “ca-apm-runpy ” + strings.Join(argList, “ ”)

}

Once the appropriate handler has been selected, the modify component 206 utilizes the handler to modify the first command to create the second command. To do so, the handler may access a modification from a set of modifications. The modification corresponds to the portion of the command that is to be modified. If no modification is found, the first command may not be modified. In this case, the second command that is executed is the first command. If a modification command is found, the modify component 206 utilizes string manipulation code and the modification to modify the first command to create the second command. Once the second command is created, execute component 208 passes the second command to the operating system to be executed. Additionally, execute component 208 prevents the first command from being executed by the operating system. An exemplary string manipulation code and exemplary modifications are shown in Tables 4 and 5, respectively.

TABLE 4
package main
import (

“os”
“log”
“bufio”
“strings”
“./handlers”
“fmt”

)
func main( ) {

// Command to modify
commandString := os.Args[1:]
//Handler Maps
funcMap := map[string]func([ ]string, int) string{

“python”: handlers.PyModify,
“java”: handlers.JModify,

}
//Map for the match file
matchMap := map[string]string{ }
//Open log file
logFile, err := os.OpenFile(“modifier.log”,

os.O_RDWR\os.O_CREATE\os.O_APPEND, 0666)

if err != nil {

//do nothing
os.Exit(0)

}
defer logFile.Close( )
log.SetOutput(logFile)
//open match file
matchFile, err := os.Open(“words.txt”)
if err != nil {

log.Println(err)
log File.Close( )
//do nothing
os.Exit(0)

}
defer matchFile.Close( )
//read match file into map
scanner := bufio.NewScanner(matchFile)
for scanner.Scan( ) {

keyValue := strings.Split(scanner.Text( ), “:”)
if len(keyValue) == 2 {

matchMap[keyValue[0]] = strings.Trim(keyValue[1],”

\n\r\t”)

}

}
if err := scanner.Err( ); err != nil {

log.Prmtln(err)

}
//Parse command string
for i, str := range commandString {

val, ok := matchMap[str]
if ok {

handler, ok2 := funcMap[val]
if ok2 {

changedCommand := handler(commandString,

i)

if changedCommand!=“”{

fmt.Println(changedCommand)

}

}

}

}

]

TABLE 5

gunicorn:python
runserver:python
org.apache.catalina.startup.Bootstrap:java

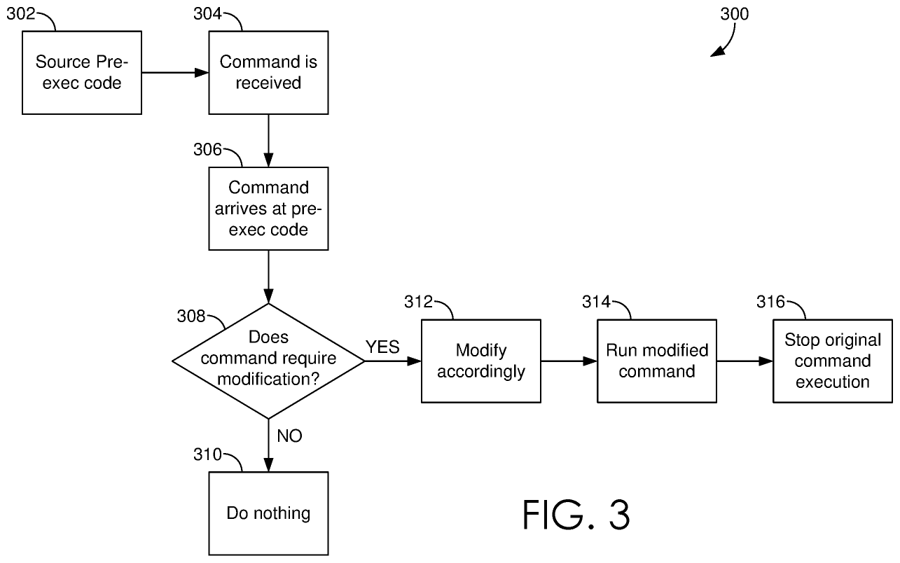

In FIG. 3, a flow diagram is provided that illustrates a method 300 of providing agent injection via command hijacking, in accordance with embodiments of the present disclosure. For instance, the method 300 may be employed utilizing the hijack system 100 of FIG. 1. As shown at step 302, the pre-execution code is initially sourced in a global location. Alternatively, the location of the pre-execution code may be identified by an environment variable.

A command is received, at step 304. The command may be issued by a user via a shell and intended for execution by the operating system. Before being executed by the operating system, the pre-execution code intercepts the command, at step 306.

It is determined, at step 308, if the command requires modification. Exceptions may be defined by the pre-execution code that enable the command to be executed by the operating system without modification, as shown at step 310.

If no exception is defined by the pre-execution code, the command can be modified, at step 312. Once the command has been modified, the modified command is communicated to the operating system for execution, at step 314. Additionally, the original command is prevented from being executed, at step 316.

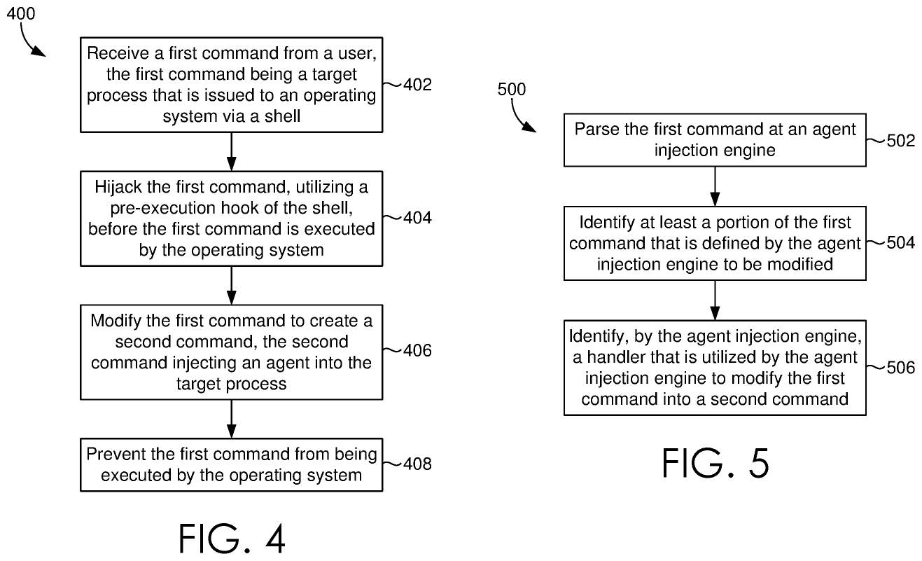

Turning now to FIG. 4, a flow diagram is provided that illustrates a method 400 of providing agent injection via command hijacking, in accordance with embodiments of the present disclosure. For instance, the method 400 may be employed utilizing the hijack system 100 of FIG. 1. As shown at step 402, a first command is received from a user, such as via a user device. The first command includes a target process that is to be issued to an operating system via a shell.

Before the first command is executed by the operating system, the first command is hijacked, at step 404, utilizing a pre-execution hook of the shell. In some embodiments, the first command is hijacked by passing the first command to an agent injection engine, such as agent injection engine 200 of FIG. 2. The first command is modified to create a second command, at step 406. The second command injects an agent into the target process. This can be accomplished without preloading the agent into memory. In embodiments, the agent is utilized to collect data from the target process.

The second command may be enabled to be executed by the operating system. At step 408, the first command is prevented from being executed by the operating system.

In FIG. 5, a flow diagram is provided that illustrates a method 500 of modifying a command, in accordance with embodiments of the present disclosure. For instance, the method 500 may be employed utilizing the hijack system 100 of FIG. 1. As shown at step 502, a first command issued to an operating system via a shell is parsed, by an agent injection engine. The agent injection engine may be sourced in a global location. Alternatively, a location of the agent injection engine may be identified in an environment variable. The first command is hijacked by the agent injection engine and includes a target process. For example, the agent injection engine may set a debug flag, at the shell, to hijack the first command.

In some embodiments, the agent injection engine may store a local copy of the first command. At least a portion of the first command is identified to be modified, at step 504, in accordance with the agent injection engine.

A handler is identified by the agent injection engine, at step 506. The handler is utilized by the agent injection engine to modify the first command into a second command. The second command injects an agent (that is not preloaded into memory) into the target process in accordance with the handler and is executed by the operating system instead of the first command.

Having described embodiments of the present disclosure, an exemplary operating environment in which embodiments of the present disclosure may be implemented is described below in order to provide a general context for various aspects of the present disclosure. Referring to FIG. 6 in particular, an exemplary operating environment for implementing embodiments of the present disclosure is shown and designated generally as computing device 600. Computing device 600 is but one example of a suitable computing environment and is not intended to suggest any limitation as to the scope of use or functionality of the inventive embodiments. Neither should the computing device 600 be interpreted as having any dependency or requirement relating to any one or combination of components illustrated.

The inventive embodiments may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The inventive embodiments may be practiced in a variety of system configurations, including handheld devices, consumer electronics, general-purpose computers, more specialty computing devices, etc. The inventive embodiments may also be practiced in distributed computing environments where tasks are performed by remote-processing devices that are linked through a communications network.

With reference to FIG. 6, computing device 600 includes a bus 610 that directly or indirectly couples the following devices: memory 612, one or more processors 614, one or more presentation components 616, input/output (I/O) ports 618, input/output (I/O) components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer-storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

As can be understood, embodiments of the present disclosure provide for an objective approach for injecting an agent into a process via command hijacking. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method comprising:
receiving a first command from a user, the first command including a target process that is issued to an operating system via a shell;
hijacking the first command, utilizing a pre-execution hook of the shell, before the first command is executed by the operating system;
modifying the first command to create a second command, the second command injecting an agent into the target process; and
preventing the first command from being executed by the operating system.

2. The method of claim 1, further comprising enabling the second command to be executed by the operating system.

3. The method of claim 1, wherein the agent is utilized to collect data from the target process.

4. The method of claim 1, wherein hijacking the first command comprises passing the first command to an agent injection engine.

5. The method of claim 4, further comprising parsing the first command at the agent injection engine.

6. The method of claim 5, further comprising identifying at least a portion of the first command to be modified in accordance with the agent injection engine.

7. The method of claim 6, further comprising identifying a handler that is utilized by the agent injection engine to modify the first command, the handler corresponding to a code type of the first command.

8. The method of claim 1, wherein the agent is not preloaded into memory.

9. The method of claim 4, further comprising sourcing the agent injection engine in a global location.

10. The method of claim 4, further comprising identifying a location of the agent injection engine in an environment variable.

11. The method of claim 1, further comprising setting a debug flag, at the shell, to hijack the first command.

12. The method of claim 4, further comprising, storing, by the agent injection engine, a local copy of the first command.

13. A computer storage medium storing computer-useable instructions that, when used by at least one computing device, cause the at least one computing device to perform operations comprising:
parsing, by an agent injection engine, a first command issued to an operating system via a shell, the first command being hijacked by the agent injection engine and including a target process;
identifying at least a portion of the first command to be modified in accordance with the agent injection engine; and
identifying, by the agent injection engine, a handler that is utilized by the agent injection engine to modify the first command into a second command, the second command injecting an agent that is not preloaded into memory into the target process in accordance with the handler and being executed by the operating system instead of the first command.

14. The method of claim 13, further comprising setting a debug flag, at the shell, to hijack the first command.

15. The method of claim 13, further comprising, storing, by the agent injection engine, a local copy of the first command.

16. The method of claim 13, wherein the agent is utilized to collect data from the target process.

17. The method of claim 13, further comprising sourcing the agent injection engine in a global location.

18. The method of claim 12, further comprising identifying a location of the agent injection engine in an environment variable.

19. A computerized system comprising:
a processor; and
a computer storage medium storing computer-useable instructions that, when used by the processor, cause the processor to:
receive a first command from a user, the first command including a target process that is issued to an operating system via a shell;
hijack the first command, utilizing a pre-execution hook of the shell, before the first command is executed by the operating system; and
determine whether to modify the first command to create a second command, the second command injecting an agent into the target process and preventing the first command from being executed by the operating system.

20. The computerized system of claim 19, further comprising:
parsing the first command to identify at least a portion of the first command that is determined to be modified;
identifying a handler that is utilized to modify the first command, the handler corresponding to a category of the first command; and
modifying the first command to create the second command.
